(19) United States
(12) Patent Application Publication
(10) Pub. No.: US 2013/0038062 A1
(43) Pub. Date: Feb. 14, 2013

(54) SYSTEM FOR PRODUCING HYDRAULIC TRANSIENT ENERGY

(71) Applicant: Samusideen Adewale Salu, Ras Tanura (SA)

(72) Inventor: Samusideen Adewale Salu, Ras Tanura (SA)

(21) Appl. No.: 13/560,549

(22) Filed: Jul. 27, 2012

Related U.S. Application Data
(60) Provisional application No. 61/574,228, filed on Jul. 29, 2011.

(51) Int. Cl. F15B 21/12; F01D 15/10; F03B 17/04

(52) U.S. Cl. 290/52; 60/532; 415/916

(57) ABSTRACT

A system is disclosed for Hydraulic Transient Energy Generation, based on the principle of hydraulic transients involving conversion of kinetic energy into potential (pressure) energy, which will serve as a reliable, renewable, inexpensive and green source of energy, and provide good environmental benefits (and CO₂ credit) by substantially minimizing greenhouse gas emissions. To utilize the potential (pressure) energy developed in the system, the invention makes the transient pressure surge continuous and steady. Rapid response valves with appropriate and compatible instrumentation systems make it possible to periodically and continuously induce pressure surges to maintain high pressure at the outlet of the system. The steady pressure rise at the outlet of the system can be used to drive a turbine for generating electrical power, or for pumping liquid from lower pressure to a higher pressure, wherein it can be used for driving pumps, compressors and the like which require energy input for their operation.

### CROSS-REFERENCE TO RELATED APPLICATIONS

This application claims priority to U.S. provisional application No. 61/574,228, filed Jul. 29, 2011, the disclosure of which is incorporated by reference herein and made a part of this application.

### BACKGROUND OF THE INVENTION

1. Field of the Invention

The present invention relates to a system for generating useful “green” energy by conversion of kinetic energy to potential energy through the use of intentionally and sequentially provoked hydraulic pressure surges in hydraulic lines.

2. Description of the Related Art

Hydraulic pressure surge occurs when a liquid flowing in conduit is suddenly stopped by a fast-closing valve resulting in a pressure wave that propagates upstream of the valve. The fast deceleration of the flowing liquid occurs at the speed of sound (in the liquid) and results in a high pressure surge due to the transformation of kinetic energy to potential energy. The speed of sound in air is estimated to be 343.2 meters per second, or 1126 ft. per second. The speed of sound in water is estimated to be up to about 1403 meters per second at 0° Centigrade, and is higher at elevated temperatures.

For example, as noted, the speed of sound in water is estimated to be about 1403 meters per second at 0° Centigrade, and rises up to about 1543 meters per second at 100° Centigrade. Accordingly, it can be appreciated that the resulting pressure surge in water is relatively instantaneous, and the transformation is substantial.

One known example of the creation of such energy transformation is evident in the well known ABS (i.e., “Anti-lock Brake System”) braking systems used in modern day motor vehicles. In such systems, depression of the brake pedal by the operator causes a sequence of hydraulically produced waves produced by sequential closing and opening of a sensor/valve system. While such ABS systems are not used to transform and harness energy for an independent use, they are noted herein as an illustrative example of the phenomenon of sequential sensing and respective wave production in hydraulic circuits.

To date, various arrangements and devices have been used to harness energy which is generated by pressure surges in hydraulic lines. In particular, attempts have been made to transform such kinetic energy to potential energy to produce various types of outputs.

For example, U.S. Pat. No. 3,690,403 is directed to the creation of compressional waves along a length of elongated pipe by high energy supply of fluid directed against a piston.

US Patent Publication No. 2009/0152871 relates to a system which produces energy using re-booster pumps which receive energy from a starting/re-boosting generator.

U.S. Pat. No. 3,805,896 relates to a hydraulic repeating hammer which has a hydraulically actuated striking piston for movement in a cylinder.

U.S. Pat. No. 4,271,925 is directed to a fluid actuated acoustic pulsed generator system including an elongated tubular member of uniform elastic parameters constructed for receiving fluid flow therein and abruptly terminating the flow to create an acoustic pulse containing most of the acoustic energy in the zero to 160 Hertz frequency spectrum. The system generates a dimensionally distinctive acoustic pulse.

U.S. Pat. No. 5,507,436 relates to a method and apparatus for converting pressurized low continuous flow to high flow inpulses.

U.S. Pat. No. 5,519,670 relates to a water hammer driven cavitation chamber.

U.S. Pat. No. 5,549,252 is directed to a water hammer actuated crusher for crushing material such as rock.

U.S. Pat. No. 5,626,016 is directed to a water hammer driven vibrator having deformable vibrating elements. The system produces high pressure pulses used to vibrate industrial apparatus such as shaking screens, shaking tables, hoppers, bins or the like.

U.S. Pat. No. 7,051,525 is directed to a method and apparatus for monitoring operation of a percussion device.

U.S. Pat. No. 7,059,426 relates to an acoustic flow pulsing apparatus and method for drill string. The pulsation can be used to drive the operation of various downhole tools.

Finally, U.S. Pat. No. 7,448,361 is directed to a fuel injection system which utilizes pressure waves to inject fuel at higher pressure to an internal combustion engine.

While the production of such pulses through water hammer principles in hydraulic systems has been generally known, none of the known disclosures is directed to the safe and efficient production of “green” energy utilizing such water hammer principle as is disclosed in the present application.

I have invented a system for generating useful “green” energy from hydraulic flow in a system in which the energy is produced on a continuous basis by continuously and periodically inducing the production of pressure surge waves in such a manner as to convert transient phenomenon into steady state phenomenon. In particular, I have invented a system in which kinetic energy is transformed into potential energy which is greater than the initial value of the kinetic energy, whereby the hydraulic pressure is significantly increased and made available for useful purposes.

### SUMMARY OF THE INVENTION

The invention relates to a process flow scheme for “Hydraulic Transient Energy Generator.” The invention is based on the principle of hydraulic transients involving conversion of kinetic energy into potential (pressure) energy. The invented Hydraulic Transient Energy Generating System will serve as a reliable, renewable, cheap and green source of energy. The invention will provide good environmental benefits by substantially minimizing greenhouse gas emissions and provide CO₂ credit.

To take advantage of the potential (pressure) energy developed in the system as a result of this transient phenomenon, a means of making the transient pressure surge continuous and steady has been invented. The invention involves the use of rapid-response-valves with instrumentation system to continuously and periodically induce pressure surges to maintain high-pressure as the outlet of the system. The steady pressure rise at the outlet of the system can either serve as a means for pumping liquid from lower pressure to higher pressure or alternatively can be utilized to drive a turbine in generating useful work for driving pumps, compressors and for electrical power generation. A fit-for-purpose process flow scheme has been invented for the Hydraulic Transient Energy Generating System.

In particular, a system is disclosed for producing electrical energy utilizing the principle of hydraulic water hammer, which comprises a hydraulic system which includes a hydraulic feed line, a surge conduit connected to said feed line and capable of carrying a liquid at a first predetermined velocity and pressure, a plurality of sensors and valves coupled to the surge conduit, the valves being capable of selectively opening and closing periodically and continuously in response to respective signals provided by a selective number of said sensors. An instrumentation system is operatively connected to the system of valves and sensors to selectively and sequentially control the opening and closing of selected valves in a manner to continuously and periodically induce pressure surge waves of relatively elevated pressures in the liquid. Means is provided for directing the pressure surge waves to compatible devices for producing electric power generation.

The compatible devices for producing electrical energy from the pressure surge waves of elevated pressures preferably comprise hydro-turbines. The compatible devices further comprise electric generating equipment coupled to the hydro-turbines.

The liquid is preferably water, and the plurality of sensors and valves comprise at least one of each of a Surge Pressure Valve, a Flow Indicator and Transmitter, a Pressure Indicator & Transmitter, a Velocity Indicator and Transmitter and Surge Relief Valve, respectively arranged to continuously and periodically induce pressure surge waves in said hydraulic surge system. The surge conduit is preferably comprised of carbon steel having a polymer internal coating. Further, the cross-sectional size of the surge conduit is less than the cross-sectional size of the feed line.

In a preferred embodiment, the feed line is connected to a system of dual surge conduit sub-systems, each surge conduit forming part of a separate and individual surge system associated with a respective plurality of sensors and valves arranged to sense water pressure, velocity and flow, and to selectively signal a respective surge pressure valve to close to thereby produce a pressure surge wave. Furthermore, the sensors and transmitters are adapted to continuously and periodically produce the pressure surge waves.

The system further comprises hydro-turbines and means to selectively direct the pressure surge waves to the hydro-turbines to power the hydro-turbine. The hydro-turbines are each coupled to an electric generating device which produces green electrical power when powered by the hydro-turbines.

In this preferred system, each surge conduit sub-system is adapted to continuously and periodically produce surge pressure waves in alternate cycles of between one and two seconds, in cascade mode, wherein one conduit system is in suction mode when the other conduit system is in discharge mode, and vice versa. Further, each surge conduit is preferably comprised of carbon-steel having a low friction internal coating to reduce traction, and a low friction internal coating of a synthetic polymer is provided in the conduits.

Each surge conduit sub-system may be periodically injected with a drag reducing agent which reduces friction between the flow of water and the internal wall of said conduits. The drag reducing agent may be a long chain polymer.

Preferably each surge conduit is comprised of a straight pipe. However, where space is a factor, the respective surge conduit may be comprised of a spirally wound pipe.

The system can also be utilized to drive alternative devices such as pumps, compressors and the like which require energy input.

A system is disclosed for increasing hydraulic pressure in a hydraulic system utilizing the principle of hydraulic water hammer, which comprises, a hydraulic system which includes a hydraulic feed line capable of carrying a liquid at a first predetermined velocity and pressure, a surge conduit connected to the hydraulic feed line, the surge conduit having a cross-sectional size less than the cross-sectional size of said feed line. A plurality of sensors and valves are coupled to the hydraulic system, the sensors and valves being capable of selectively opening and closing periodically and continuously in response to signals provided by a selected number of the sensors. An instrumentation flow sensor system is operatively connected to the system of valves and sensors to selectively control the opening and closing of the valves in a manner to periodically and continuously induce pressure surge waves of relatively elevated pressures in the liquid. Means is provided for directing the pressure surge waves to a high liquid pressure outlet. Preferably the liquid is water. Further, the pressure surge waves may be directed to drive pumps, compressors or a hydraulic transient energy generating system.

In particular, a system is disclosed for increasing hydraulic pressure in a hydraulic system, utilizing the principle of hydraulic water hammer, and for utilizing said increased water pressure for useful purposes, which comprises, a feed line adapted for receiving water from a source, a pump for pumping the water in the feed line, a surge conduit connected to the feed line and capable of carrying water at a first predetermined velocity and pressure, and an outlet line communicating with the surge conduit. A plurality of velocity sensors, surge pressure valves, and surge relief valves are coupled to the surge conduit, the surge pressure valves being adapted to close when receiving a signal from one of the respective sensors indicating that the water velocity has reached a pre-determined value. The valve closure produces a pressure surge wave in the system which delivers high pressure water into the outlet line, whereby a surge relief valve returns to a closed position once the pressure in the conduit declines to a normal preset valve and at the same time, a pressure sensor reopens said respective surge pressure valve to permit water to flow through and attain a predetermined velocity once again. An instrumentation system controlled by a software program is operatively connected to the system of valves and sensors to selectively control the opening and closing of the valves in a manner to continuously and periodically induce pressure surge waves of relatively elevated pressures in said liquid. At least two of the surge conduit systems are connected to the feed line to operate in cascade mode, wherein one of the conduit systems is operative in suction mode when the other conduit system is in discharge mode and vice versa.

### BRIEF DESCRIPTION OF THE DRAWINGS

Preferred embodiments of the invention are described hereinbelow with reference to the drawings, wherein:

FIG. 1 is a flow diagram of a closed circuit Hydraulic Transient Energy Generator constructed in accordance with the present invention, wherein the initial water flow is produced by a pump and electrical energy is produced by a Hydro-Turbine driven generator;

FIG. 2 is a flow diagram of an alternative embodiment of the invention, wherein an open circuit Hydraulic Transient Energy Generator is provided in a situation where continuous flow of liquid already exists in a conduit from a source or reservoir by a booster pump or by elevation, and whereby increased hydraulic pressure is produced at the outlet;

FIG. 3 is a flow diagram of a Hydraulic Transient Energy Generator System constructed in accordance with the present invention, incorporating dual parallel surge conduits to achieve continuous and steady liquid flow, wherein the system as operative in cascade mode, and one conduit is in suction-mode when the other conduit is in discharge-mode and vice versa, the process operating periodically in cycles, with each cycle taking about 1 to 2 second(s);

FIG. 4 is a flow diagram of an alternative embodiment of the invention similar to FIG. 2, wherein two parallel surge conduits are provided similar to FIG. 2, i.e., where continuous flow of liquid already exits in a conduit from a source or reservoir by a booster pump or by elevation, and whereby increased hydraulic pressure is produced at the outlet;

FIG. 5 is an example calculation sheet showing surge pressure and energy output for the embodiment of FIG. 1;

FIG. 6 is an example calculation sheet showing surge pressure for the embodiment of FIG. 2;

FIG. 7 is a chart of pressure drop calculation in Pipephase;

FIG. 8 is a flow scheme of a typical system with Transient Hydraulic Pump, constructed according to the invention;

FIG. 9 is a schematic logic diagram for the instrumentation panel as it relates to the surge conduit and output of the entire system according to the invention. The central part of FIG. 9 entitled “CONTROLLER LOGIC” represents the logic panel for “SPS”. As can be seen, either FIT″ or “VIT” can be used for the same purpose. Therefore “FIT/VIT” in FIG. 9 is generic to cover all cases in FIGS. 1, 3 and 4; and.

FIG. 10 is a sample calculation of the maximum transient pressure rise in a 2 km×4 inch XX Stg (0.674″ WT, or “wall thickness”) piping system, flowing 20,000 BPD of water using a Joukowsky equation.

### BRIEF DESCRIPTION OF THE TERMINOLOGY

In the description of the invention which follows, the following terminology is used to identify components of the systems which form part of the present invention:
1. Surge Pressure System (SPS): A system of instrumentation logic panel that includes flow sensors, and which will be responsible for continuously and periodically inducing surge pressure waves in the system. The panel will be receiving signals of flow and pressure data from sensors at appropriate locations along the conduit and will respond appropriately to send out signals to rapidly open or close the surge pressure valve (SPV).
2. Flow Indicator & Transmitter (FIT): A flow measuring device with a local display of flow readings and a data transmitting system that will transmit the flow readings to the Surge Pressure System (SPS) described in (1) above via a data communication link. It will be located at the end of the conduit close to the inlet of the elevated tank.
3. Velocity Indicator & Transmitter (VIT): A velocity measuring device with a local display of velocity readings and a data transmitting system that will transmit the readings to the Surge Pressure System (SPS) described in (1) above via a data communication link. It will be located at the end of the conduit close to the shock absorber drum.
4. Pressure Indicator & Transmitter (PIT): A pressure measuring device with a local display of pressure readings and a data transmitting system that will transmit the readings to the Surge Pressure System (SPS) described in (1) above via a data communication link. It will be located just before the Surge Pressure Valve (SPV).
5. Surge Pressure Valve (SPV): A rapid opening/closing valve with an actuator. It will receive appropriate signals to close or open the valve from the Surge Pressure System (SPS) described in (1) above. The input of flow and pressure readings will be from the communicated/transmitted data from the (FIT) and (PIT) described in (2) and (4) above.
6. Surge Relief Valve (SRV): A mechanical liquid pressure relief valve that opens and closes rapidly at preset pressures to selectively deliver high pressure water into the outlet line.
7. Recirculation Valve (RCV): Part of the pump flow control and protection system against minimum flow. It is a minimum flow recycle valve of the pump that automatically opens to recycle liquid flow to the suction of the pump on detection of flow through the pump.
8. Check Valve (CHV): A one way valve to prevent reverse flow.
9. Barrels Per Day (BPD).
10. High Signal Monitor (HSM).
11. Low Signal Monitor (HSM).
12. MBOD: One thousand barrels of liquid per day.
13. OLGA® is a software system which allows developing simulation models of real systems and setting up experiments of these models in order to analyze system behavior and assess (within limits imposed by a certain criterion or group of criteria) different strategies ensuring functioning of this system. Software system OLGA®, which was developed by a Norwegian Company, Scandpower Petroleum Technology AS, allows simulation modeling of systems with any degree of complexity. This software system is generally used for designing in the oil and gas industry.
   While designing objects in the gas industry (compressor stations, pipelines, etc.), software system OLGA® ensures the possibility to model complicated processes evoked by non-steady multiphase flow, to forecast different effects related to non-stability of the flow in the pipeline, to forecast any situations, and to work out schemes for emergencies and contingency situations elimination.
   The use of the OLGA® software system allows evaluating efficiency of different processes and sequences of emergencies and allows system modeling with different fluid properties.
   OLGA® is also used for pipeline systems modeling i.e., gathering manifolds and main pipelines. By means of OLGA® it is possible to model any systems of surface equipment, separators, compressors, pumps, heat exchangers and gate valves, besides, controlled emissions, leaks, cleaning equipment. The software system allows specialists effective research and modeling of multiple processes related to transportation of gas, oil and mixed flows.
   Various computer-based programs are available for performing rigorous hydraulic transients simulation for accurate prediction and analysis of hydraulic transients behaviors and calculating surge pressures. OLGA® is just one example of such hydraulic transients software that can be used for surge pressure calculations.
14. Drag Reducing Agent (DRA). Also called a flow improver, is a long chain polymer chemical that is used in crude oil, refined products or non-potable water pipelines. It is injected in small amounts (parts per million) and is used to reduce the frictional pressure drop along the pipeline's length.
   The benefits of using a drag reducer are the following:
   1. Increase in pipeline throughput;
   2. Reduction of the waiting time for tanker loading/offloading;
   3. Maintaining the throughput during MOL (Main Oil Line) pump maintenance for de-rated lines;
   4. Bypassing MOL pump stations; and
   5. Energy Savings.
   The chemicals dampen turbulent bursts of the oil near the pipeline wall, such that less disturbance is created during the liquid flow. Minimizing turbulence in the radial direction better preserves flow in the axial direction of the pipeline. Drag reduction effectiveness for a given concentration is based on the turbulent characteristics of the pipeline. The maximum theoretical effect is the same as a pipe in laminar flow, where all of the turbulence is eliminated by the agent. Drag reduction effectiveness is measured as a percentage of the pipeline with no DRA present. For example, 75% drag reduction is representative of a pipeline that has one-quarter (¼) of the frictional pressure loss at a given flow rate.
   Since DRA is composed of long polymer strands, it is prone to degradation as it travels through the pipeline due to shearing of the strands. Large pressure changes through a control valve or pump result in a total loss of effectiveness. DRA may be reinjected after such equipment, but the total injection is usually limited by the product specifications or fluid limitations. DRA should never be used with any turbine fuels (such as jet fuel) because the polymer will accumulate on turbine blades and may damage the turbine.
   The use of such drag reducers has allowed pipeline systems to greatly increase in traditional capacity and extend the life of existing systems. The higher flow rates possible on long pipelines have also increased the potential for surge on older systems not previously designed for such high velocities as the systems contemplated by the present invention.
15. XX Stg: A designation of pipe in a piping system denoting “Extra Extra Strong”, which refers to wall thickness (i.e., WT) as used in standard pipe tables.
16. PFD is a Process Flow Diagram, i.e., a schematic illustration of the system.
17. P&ID is a piping and instrumentation diagram which shows the piping of the process flow together with installed equipment and instrumentation.
18. HYDRO-TURBINE is a rotary engine that takes energy from moving water.

### DESCRIPTION OF THE PREFERRED EMBODIMENTS

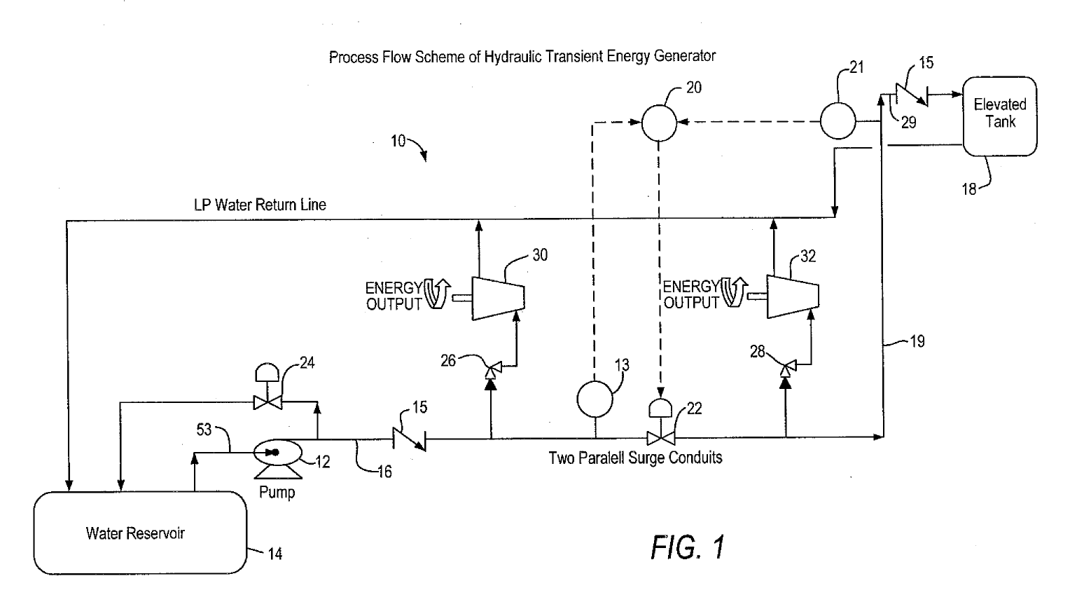

Referring initially to FIG. 1, the principle and mode of operation of the Hydraulic Transient Energy Generator constructed according to the present invention is illustrated by way of a closed-loop hydraulic system 10. In particular, the system shown in FIG. 1 involves pumping water (or any heavier liquid) by pump 12 from a reservoir 14 to cause it to flow through conduit 16 at a high velocity to a smaller overhead tank 18 at the other end. Immediately thereafter, water will arrive close to the location of the overhead tank 18, and a flow surge pressure sensor system 20 (SPS) installed at this point will detect its arrival and send a signal to close a surge pressure valve 22 (SPV) almost instantaneously. Flow sensor system 20 includes pressure indicator and transmitter 13 and flow indicator and transmitter 21. The rapid closure of the valve 22 will induce a pressure surge in the system. To protect the pump from flowing against the closed check valve, a recirculation valve 24 (RCV) will open almost immediately after closure of the surge pressure valve 22 (SPV). Due to the high flow velocity of the water in the conduit 16, it will gain high kinetic energy until it is forced to stop suddenly by the valve 22 and it will thereby transform the kinetic energy into potential energy in the form of a water hammer. The pressure surge thus created will force surge relief valves 26, 28 (denoted SRV-1 & 2) to open and deliver high pressure water to drive hydro-turbines 30, 32 for energy generation. The surge relief valves 26, 28 will then close back to their original positions once the pressure in the system declines to a normal predetermined set point. Then the pressure sensor will reopen the surge pressure valve 22 at the same time for the whole process to be repeated in cycles within a period of approximately one (1) second. Check valve 15 is shown in FIG. 1. Return line 19 is shown.

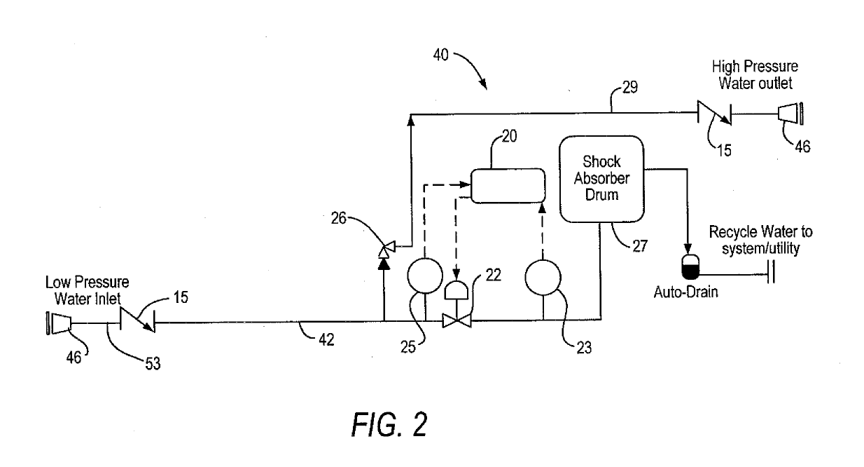

Referring now to FIG. 2, there is illustrated a hydraulic system 40 similar to FIG. 1, but wherein a continuous flow of liquid already exists in a conduit 42 from a source or reservoir 44 by a booster pump 46. Alternatively, the source or reservoir 44 may be elevated, and it is thereby required to pump the liquid to higher pressure by pump 46. In this embodiment, the flow scheme shown in FIG. 1 is modified to be adapted to the open loop system shown in FIG. 2. A typical example of such arrangement is water from the Wasia wells of Saudi Arabia, with submersible pumps or from water/oil separators (WOSEP) with horizontal booster pumps and feeding water injection pumps of the type presently used in certain water injection plants. As noted, Wasia wells is one of the major aquifers in Saudi Arabia, and is only referred to as an example. Velocity Indicator & Transmitter (VIT) 23 is shown. Pressure Indicator & Transmitter (PIT) 25 is shown. Shock Absorber Drum 27 is provided.

In FIG. 2, the main objective is to produce high pressure flow from relatively low pressure flow. In each embodiment the cross-sectional size of the relevant surge conduit is less than the cross-sectional size of the initial feed line. The elevated pressure occurs in the outlet line 29 in FIG. 2.

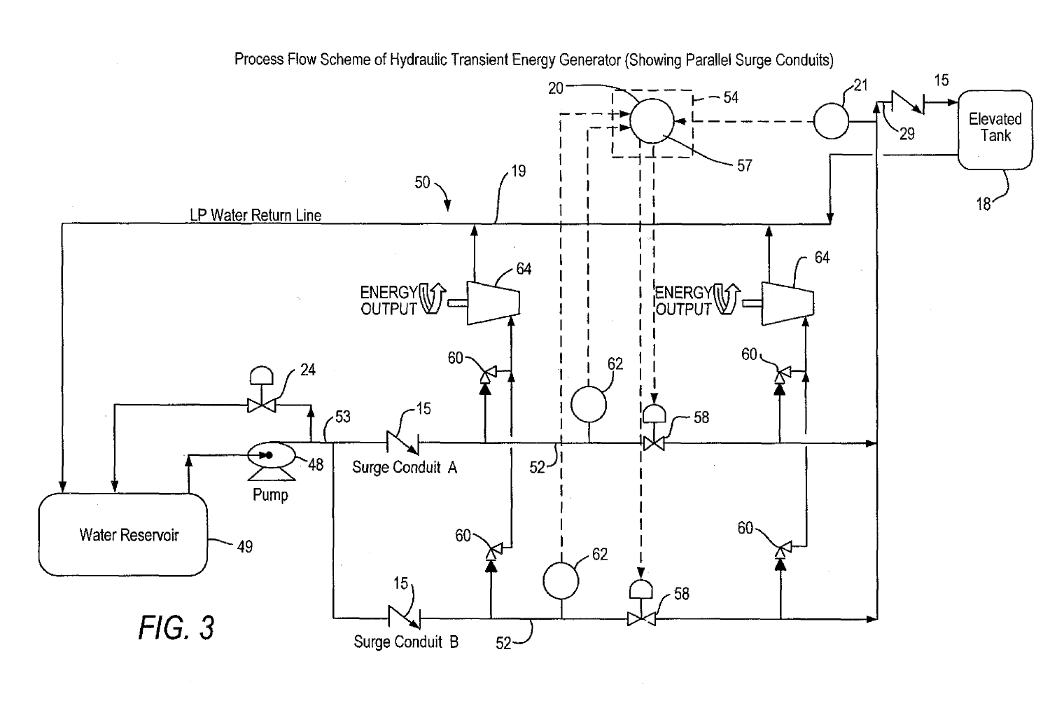

In the embodiment of FIG. 3, Hydraulic Circuit 50 is shown. In this embodiment, the liquid should be flowing by pump 48 at a velocity and at enough suction pressure to overcome frictional loss that will be required in each surge conduit 52. The liquid velocity will be increased in the respective surge conduit 52, which will be of far smaller diameter than the feed line 53. Once the liquid flows toward the end of the surge conduit 52, an instrumentation logic panel 54 (SPS) which includes Velocity Indicator and Transmitter 57 (VIT) installed at this point will detect its arrival and send a signal to rapidly close the respective surge pressure valve 58 (SPV). The rapid closure of the valve 58 (SPV) will induce a pressure surge in the system. The pressure surge will force surge relief valve 60 (SRV) to open at a preset pressure and to deliver high pressure water into the outlet line. The surge relief valve 60 will then close back to the preset position once the pressure in the system declines to a predetermined normal set-point. At the same time a respective pressure indicator and transmitter 62 (PIT) will reopen the surge pressure valve 58 for liquid to flow through and once again attain the required velocity again. The entire process as described above will be repeated in cycles within a period of approximately one (1) second, thereby keeping the pressure of the outlet liquid from the system at the required high discharge pressure to drive turbine 64.

To make the pressure rise and flow continuous and steady state, the process is repeated in periodic cycles that are measured in seconds. Furthermore, in this preferred embodiment, to achieve continuous and steady liquid flow, the dual system of surge conduits will be used as will be described hereinbelow in expanded flow schemes. Such dual conduit system will operate in cascade mode, i.e., while one conduit is in suction mode, the second conduit will be in discharge mode, and vice versa. For this reason, the components of each of the individual systems in FIG. 3 bear identical numerals. Return line 19 is shown.

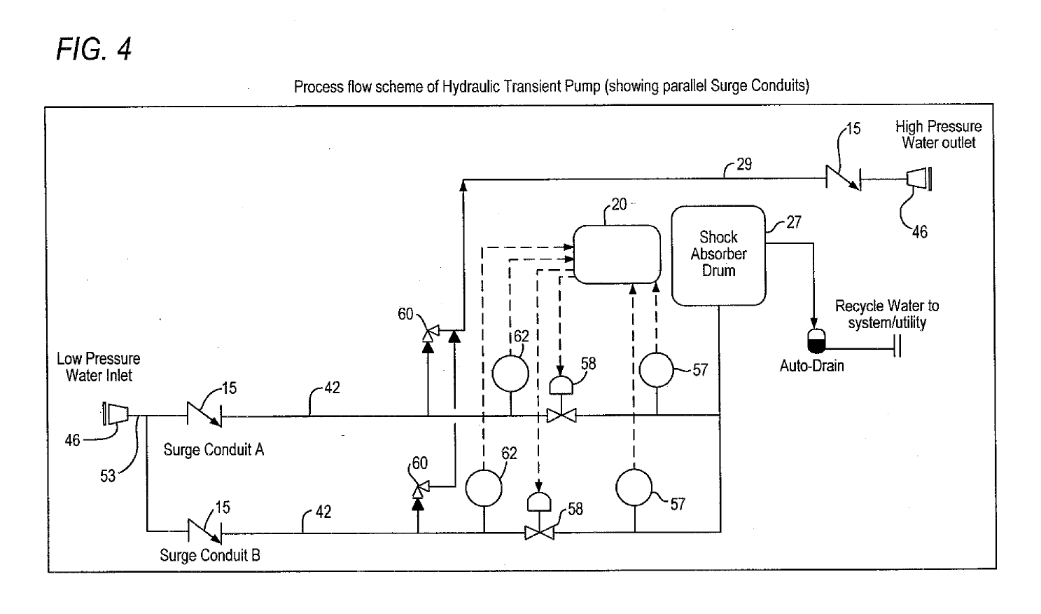

FIG. 4 is a flow diagram of a dual Hydraulic Transient Energy Generating System similar to FIG. 3, wherein continuous flow of liquid already exists in a main feed line from a source or reservoir 59 by a booster pump or by elevation as in FIG. 2. In this system, the process is repeated in each flow system in periodic cycles in cascade mode, wherein our conduit is in suction mode, and the other conduit is in discharge mode, and vice versa, as in the dual system of FIG. 3. Velocity Indicator & Transmitter 57 is shown. In a manner similar to FIG. 2, the system in FIG. 4 produces high pressure water from initially low pressure water in feed line 53 to high pressure water in outlet line 29. This high pressure water can be used to power turbines, generators, pumps, compressors and the like.

A significant feature of the present invention is to establish a system of liquid flowing in a conduit at the requisite velocity, and to provide the system with an instrumentation system that is capable of continuously and periodically inducing pressure surge waves in the system. The objective is to convert transient hydraulic phenomenon of water hammering that develop surge pressure waves which move through the conduit at a speed of sound into a continuous and steady-state phenomenon. This will thereby steadily maintain high-pressure at the outlet of the system. The steady pressure rise at the outlet of the system can either serve as a means of pumping liquid from lower pressure to higher pressure or alternatively, can be utilized to drive a turbine in generating useful work for driving pumps, compressors and for electrical power generation.

As noted, to achieve continuous and steady liquid flow, a dual system of surge conduits will be used. Whenever one conduit is in suction mode, the second conduit will be in discharge mode and vice versa.

### A Significant Objective of the Invention

This invention makes it possible to develop a transient phenomenon i.e., hydraulic transient into a steady state continuous process to take the benefit of potential (pressured) energy developed by the transient phenomenon, and to transform such transient phenomenon into “green” energy, i.e., energy which is produced without harming the environment.

Particular Features of the Invention—How it Differs from Current Practice

A significant feature of the present invention is unique in that it presents a most reliable source of renewable energy. It is capable of producing energy non-stop, without consumption of any raw material or combustion of fuel, therefore making it qualified as “green” energy. It will be flexible operationally and the energy output from the system can be controlled. It will be a renewable source of energy that will not be affected by seasonal changes, unlike other sources such as hydroelectric dams, solar, wind and wave. Moreover, in addition to producing such “green” energy, the present invention makes it possible to increase the pressure in a hydraulic system for use in its upgraded form or for application to other uses.

### Other Considerations

The following factors should be considered in connection with the present invention as depicted in the flow schemes in the drawings:

1. Surge Conduit Length & Configuration—for optimum performance the surge conduit length should be such that it will ensure the surge valve closure time is less or equal to the period of the pressure shock wave in the conduit. Typically for a valve closure time of 1-2 second(s), a conduit length equivalent to about 500-1000× Internal Diameter of the conduit will be required. Typically the use of a straight conduit will provide a better efficiency, but with the required length of up to a few kilometer(s) in some instances, land requirements to install lengthy conduits will represent a major factor.

2. Conduit Material—the material for the conduits must be inelastic, strong and rigid, for better efficiency. Carbon steel pipes with polymer internal coating are preferred. Other suitable materials of comparable strength are contemplated without departing from the scope of the invention. In general, the higher the modulus of elasticity of the conduit material, the higher the surge pressure capability.

3. Frictional Loss—in a liquid flowing conduit with a valve at the delivery point, sudden closure of the valve will lead to a pressure shock that translates upstream at the dynamic wave-speed, i.e., related to the speed of sound in liquid. If the conduit is operating with negligible frictional pressure drop, the shock will reach the inlet of the conduit where it will be reflected. If the conduit is operating with an appreciable frictional pressure drop, the original shock will be attenuated as it moves upstream and may never be detected. Therefore, any internal frictional loss in the conduit will depreciate the surge pressure and lower the overall efficiency of the system. For this reason, an internal coating of a suitable polymer or other suitable material is specified in the present invention.

4. High Flow Velocity—very high liquid flow velocity in the surge conduit will be required for optimum results. Erosional and noise problems will require additional improvements.

5. Wear & Tear of Valves & Instrumentation System—frequent wear and tear of valves and instrumentation systems are envisaged due to the continuous opening and closing action within cycles of seconds.

6. Stresses, Vibration and Integrity Failure—all pipes, supports, equipments, etc. associated with the invented system shall be constantly subjected to stresses, vibration or movement due to the surge forces.

### Examples of Predetermined Situations Which May Arise

Table 1 below summarizes proposed solutions to address predetermined situations which may arise in connection with the practice of the present invention.

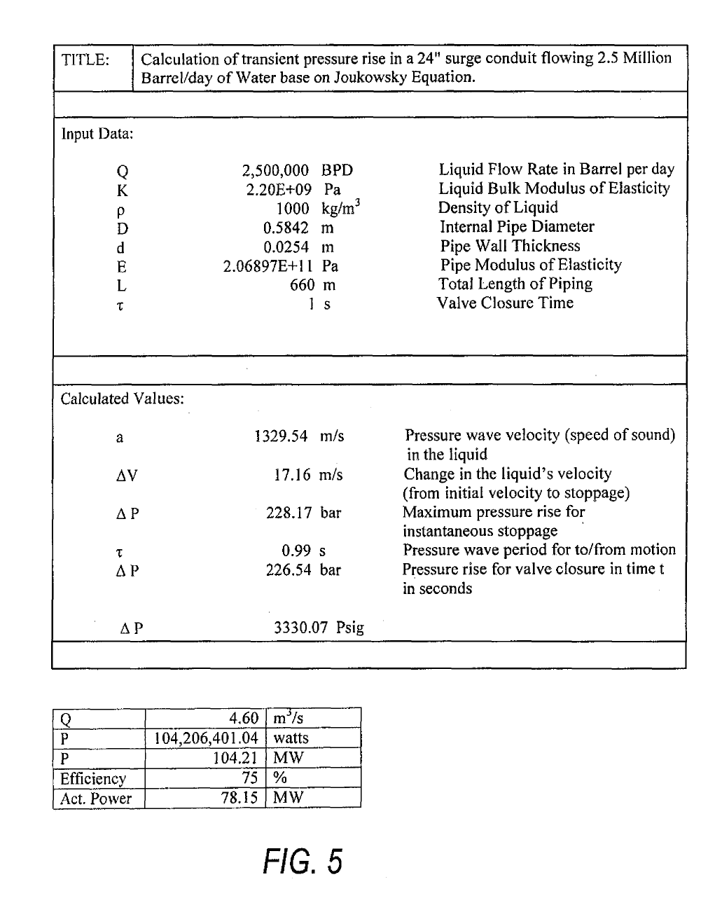

TABLE 1
Conditions and Proposed Solutions

| S/N | Conditions | Proposed Solution |
|---|---|---|
| 1. | Surge Conduit Length & Configuration - | In order to minimize the surge conduit |
| | for optimum performance the surge conduit | length a fast-closing/opening surge and |
| | is comprised of carbon steel pipes with | relief valves will be selected. A straight |
| | polymer internal coating, and the length of | conduit will be considered in the first |
| | the conduit should be such that it will ensure | instance for better result and ease of |
| | the surge valve closure time is less or equal | constructability. It is also contemplated |
| | to the period of the pressure shock wave in | that a spirally wound conduit could be |
| | the conduit. Typically for a valve closure | used to further limit the conduit length. |
| | time of 1-2 seconds, conduit length | |
| | equivalent to about 500-1000 × Internal | |
| | Diameter of the conduit will be required. | |
| | Typically a straight conduit will give a | |
| | better efficiency but with required length of | |
| | up to kilometers in some instances, land | |
| | requirements to install a lengthy conduit will | |
| | be a major challenge. | |
| 2. | Conduit Material - This must be inelastic, strong | Conduit material shall be inelastic, |
| | and rigid material for better efficiency. The higher | strong and rigid material for better effi- |
| | the modulus of elasticity of the conduit material | ciency. Material with higher modulus |
| | the higher the surge pressure. | of elasticity shall be given preference. |
| | | As noted, the preferred material is |
| | | carbon steel with polymer internal |
| | | coating. Any equivalent material |
| | | with a low friction inner surface is |
| | | contemplated. |
| 3. | Frictional Loss - In a flowing liquid pipeline | To minimize frictional loss in the surge |
| | system with a valve at the delivery point, closure | conduit, a polymer internal coating will |
| | of the valve will lead to a pressure shock that | be applied. Internal diameter of the |
| | translates upstream at the dynamic wave-speed | conduit can be any suitable dimension in |
| | (related to the speed of sound). If the pipeline is | dependence upon the particular system. |
| | operating with negligible frictional pressure drop, | In some preferred systems the internal |
| | the shock will reach the inlet of the pipeline where | diameter of the conduit can be between |
| | it will be reflected. If the pipeline is operating | approximately .25 meter and .75 meter. |
| | with an appreciable frictional pressure drop, the | As noted, these dimensions are only |
| | original shock will be attenuated as it moves | approximate, and the conduit diameter |
| | upstream and may never be detected. Therefore, | can vary from these values. See FIGS. 5 |
| | internal friction loss in the conduit will | and 6, for example. Also injection of |
| | depreciate the surge pressure and will lower the | Drag Reducing Agent (DRA) may be |
| | overall efficiency of the system. | adopted, where required or desirable. |
| 4. | High Flow Velocity - very high liquid flow | Material with high erosional resistance |
| | velocity in the surge conduit will be required for | shall be selected. |
| | optimum result. Erosional and noise problems will | |
| | need to be addressed. | |
| 5. | Wear & Tears & Instrumentation System - | All instrumentation devices, valves, |
| | Frequent wear and tear of valves & | controllers, actuators etc. in the system |
| | instrumentation system may occur due to | shall be of high-integrity, robust and |
| | continuous opening and closing actions | rugged design in order to withstand the |
| | within cycles comprised of seconds. | repeated shocks in the system. |
| 6. | Stresses, Vibration and Integrity Failure - All | All supports for the surge conduits and |
| | supports for the surge conduits and associated | associated piping/equipment in the |
| | piping/equipment in the system shall be stiffened | system shall be stiffened and designed |
| | and designed to withstand worst case surge forces & | to withstand worst case surge forces |
| | stresses and to prevent vibration or movement. | and stresses and to prevent vibration |
| | Shock absorbers etc shall be used where | or movement. Shock absorbers etc. |
| | necessary. | shall be used where necessary. |

### Case Studies (Examples to Illustrate the Invention)

### Case 1 for Power Generation

Referring to FIG. 5, a sample calculation is shown which indicates that a 660 m×24″ (i.e., inches) NB (i.e., nominal bore) surge conduit flowing 2.5 million barrel/day of water could generate up to 78 MW (i.e., Megawatts) of energy in a turbine of 75% efficiency utilizing the present invention. Analysis in a PIPEPHASE hydraulic simulation indicates that about 197 psig pressure drop will occur in the 600 m×24″ surge conduit. Approximately 8 MW of the generated energy will be utilized for pumping liquid from the reservoir to cause it to flow in the surge conduit and overcome the pressure loss. The balance energy outputs obtainable from the system will be 70 MW.

### Case 2 for Water Injection Pumping

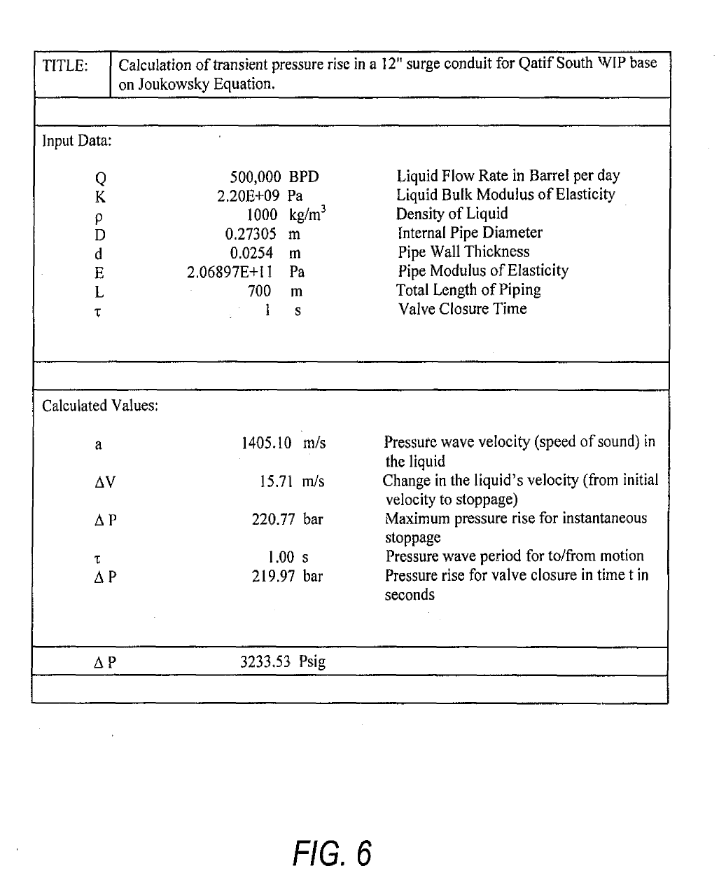

Using the design parameters of the Saudi Arabia's Qatif South Water Injection Pumps as an example case study illustrated in FIG. 6, there are 3×50% pumps (i.e., two pumps running and one stand-by). The water injection capacity for each pump is 250 MBOD, with suction and discharge pressures of 180 psig and 3000 psig respectively. A preliminary sizing calculation (i.e., refer to FIG. 6 for the calculation sheet) indicates that a 700 m×12″ (i.e., inches) NB size pipe will be adequate as the surge conduit. The calculated surge pressure for 500 MBOD is 3234 psig.

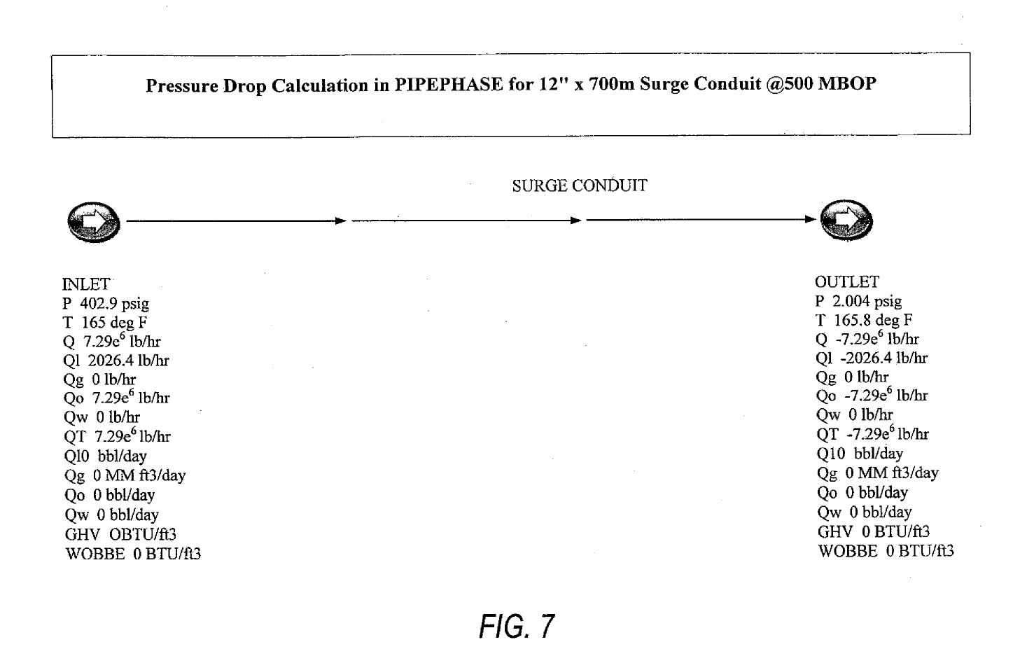

Referring now to FIG. 7, analysis in a PIPEPHASE hydraulic simulation indicates that about 400 psig pressure drop will be required in the 12″ (i.e., inches) surge conduit. The apparent pressure gain is the sum of the surge pressure and suction pressure to the system minus the frictional loss in the conduit. Therefore, for the calculated case, pressure gain=3234+180−400=3014 psig.

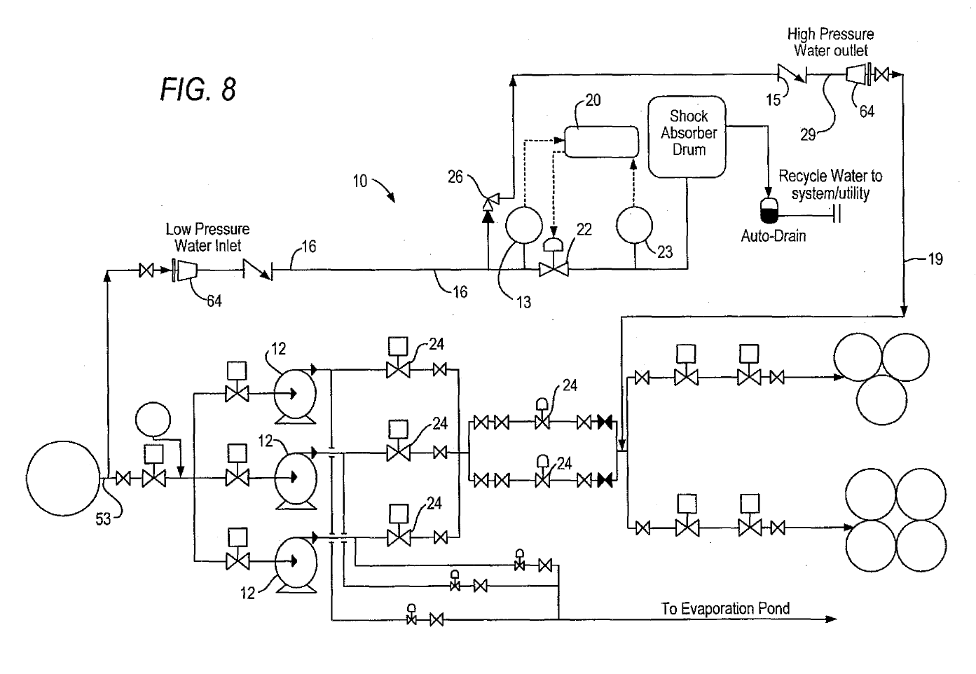

Referring now to FIG. 8, for example, if the hydraulic transient pumping system is utilized in place of the existing water injection pumps in Qatif South, a total of 22,000 HP of the electrical power consumption of water injection pumps in Qatif South will be conserved. Return line 19 is shown in FIG. 8.

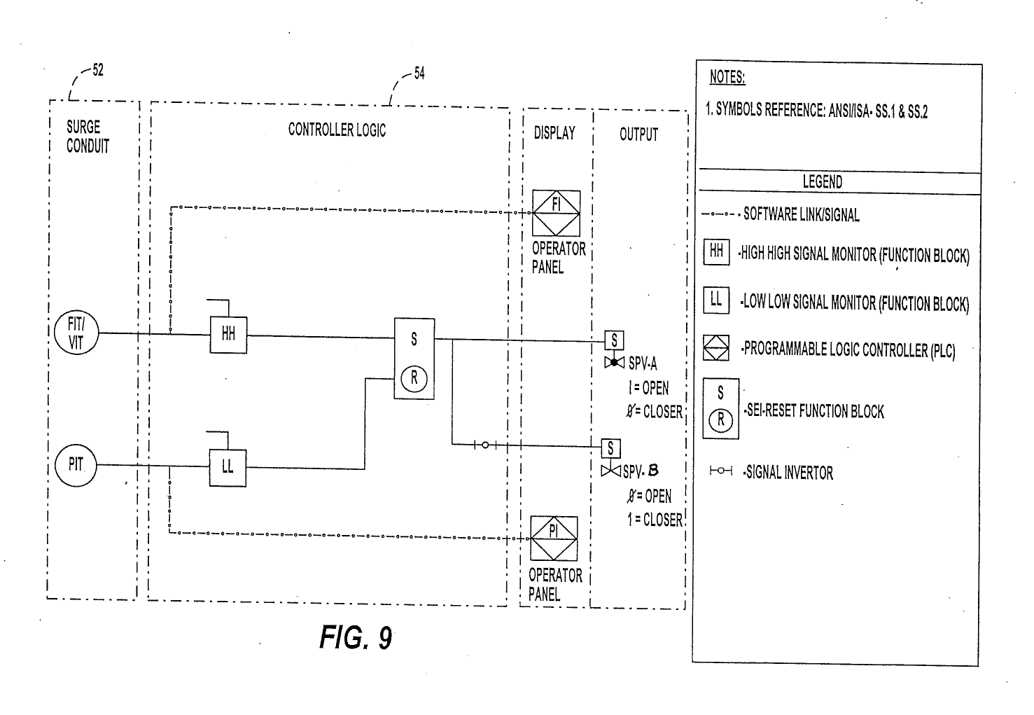

FIG. 9 is a schematic logic diagram for the instrumentation panel as it relates to the surge conduit and output of the entire system according to the invention.

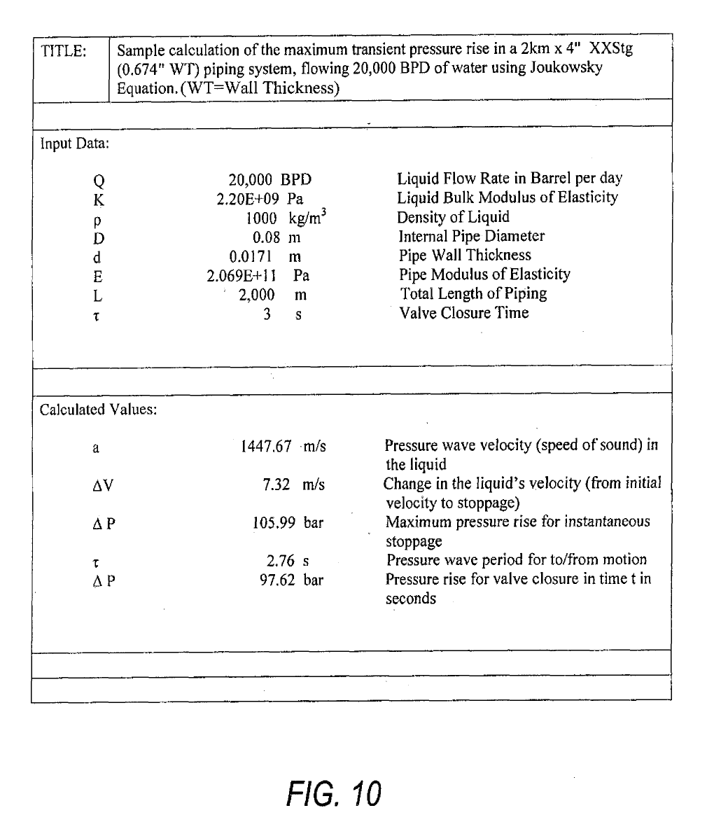

FIG. 10 is a sample calculation of the maximum transient pressure rise in a 2 km×4 inch XX Stg (0.674″ WT) piping system, flowing 20,000 BPD of water using a Joukowsky equation.

TABLE 2
Further Development & Implementation Recommendations
for Practicing the Present Invention

| S/N | Subject Development Stage | Activity Description |
|---|---|---|
| 1. | Further Concept Development | Review and optimize the already developed flow schemes |
| | | for the Hydraulic Transient Energy Generating System. |
| | | Establish a capacity basis for the optimized flow schemes. |
| | | Minimum possible capacity shall be established based upon |
| | | available Manufacturer/Vendor equipment components that |
| | | will be required in setting up a pilot model of the Hydraulic |
| | | Transient Energy Generating System. |
| 2. | Basic Engineering | Perform full scale basic engineering activities for the |
| | | Hydraulic Transient Energy Generator based upon the |
| | | optimized flow schemes and pilot-size capacity established |
| | | above. The basic engineering activities shall include |
| | | Computational Fluid Dynamics (CFD) simulations, sizing |
| | | calculations and specifications of various equipment |
| | | components, development of basic engineering drawings |
| | | PFD's, P&IDs, datasheets, etc. |
| 3. | Detail Engineering | Perform detail engineering (mechanical details, detail |
| | | electrical & instrumentation design and drawings, |
| | | equipment & material specifications, installation/ |
| | | construction drawings) required for building the pilot- |
| | | sized Hydraulic Transient Energy Generator. |
| 4. | Fabrication/Procurement | Fabricate/Procure all necessary components, equipment, and |
| | | materials required for building the pilot-sized Hydraulic |
| | | Transient Energy Generator according to design and |
| | | specifications. |
| 5. | Construction/Installation/ | Assemble all components and equipment together to build |
| | Assemblage | the pilot-sized Hydraulic Transient Energy Generator as |
| | | designed. |
| 6. | Testing and Improvement | Test run the completed pilot-sized Hydraulic Transient |
| | | Energy Generator, monitor performance and make necessary |
| | | improvements as required. |
| 7. | Field Implementation | Implement the Hydraulic Energy Generation idea in a field |
| | | and continue to improve on performance. |

Simple program for hydraulic transient calculation Transient behaviors of flows of liquids are best characterized and modeled by full time dependent equations of motion for incompressible flow. These equations are usually complex and time consuming to solve manually. Various computer-based programs are available for performing rigorous hydraulic transients simulation for accurate prediction and analysis of hydraulic transients behaviors. A good example of these proprietary hydraulic transients software is known as OLGA®, supra. However, a very quick estimate of the maximum transient pressure rise in a pipeline or piping system can be made using the Joukowsky equation. On the basis of this equation, a simple calculation routine program in an MS Excel spread sheet for quick checks of magnitude of worst case transient pressure rise possible in a piping/pipeline systems has been developed. Sample calculation sheets are provided in FIGS. 5 and 6.

The Joukowsky equation is applicable to a scenario in which a liquid flowing at a velocity in a pipe is suddenly stopped by a fast-closing valve resulting in a pressure wave that propagates upstream to the pipe inlet at a speed of sound, where it is reflected back and forth before depreciating with time. As noted, the speed of sound in water is estimated to be between approximately 1403 meters per second at 0° Centigrade and 1543 meters per second at 100° Centigrade. For example, for an instantaneous flow stoppage of a truly incompressible fluid in an inelastic pipe, the pressure rise would be infinite. Finite compressibility of the fluid and elasticity of the pipe limit the pressure rise to a finite value. This finite pressure rise is given by Joukowsky equation as follows:

ΔP=βaΔV

Where ΔP is the maximum pressure rise (Pa), ρ is the density of the fluid (kgm−3), a is the pressure shock wave (speed of sound) in the liquid (ms−1), and ΔV is the change in the velocity of the liquid (ms−1). Pa represents “PASCAL”, i.e., a unit of pressure or stress in Newton/meter² (i.e., force/area).

The pressure shock wave velocity (speed of sound), a, is given by:

$$a = \sqrt{\frac{K / ρ}{1 + KD / Ed}}$$

Where K is the liquid bulk modulus of elasticity (i.e., in this instance, Pa), E is the pipe modulus of elasticity (Pa), ρ is the density of the fluid (kgm−3), D is the internal pipe diameter, and d is the pipe wall thickness.

The maximum surge pressure occurs when the valve closes in less time than the period, τ(s) required for the pressure wave to travel from the valve to the pipe inlet and back, a total distance of 2 L, where L is the pipe length (m):

τ=2 L/a

The surge pressure will be reduced when the time of flow stoppage or valve closure, t exceeds the pipe period, τ, a rough approximation of the surge pressure in this case given by:

ΔP=(τ/t)ρaΔV.

FIG. 10 is a sample calculation of the maximum transient pressure rise in a 2 km (i.e., kilometers)×4″ (i.e., inches) XX Stg (0.674 inch WT, or wall thickness) piping system, flowing 20,000 BPD of water using the above-noted Joukowsky equation.

With reference to FIG. 10, the following clarifying information is relevant:

| | |
|---|---|
| 1. | SYMBOLS REFERENCE ANSI/ISA - SS.1 & SS.2 |

LEGEND

| | | |
|---|---|---|
| [symbol] | - | HIGH HIGH SIGNAL MONITOR FUNCTION BLOCKS |
| [symbol] | - | LOW LOW SIGNAL MONITOR FUNCTION BLOCKS |
| [symbol] | - | PROGRAMMABLE LOGIC CONTROLLER PLC |
| [symbol] | | SET-RESET FUNCTION BOX |
| \|-0-\| | | SIGNAL INVERTOR |

### LIST OF NUMERALS

10 Closed-Loop Hydraulic System (FIGS. 1 and 8)
12 Pump (FIGS. 1 and 8)
13 Pressure Indicator & Transmitter (PIT) (FIGS. 1 and 8)
14 Reservoir (FIG. 1)
15 Check Valve (FIGS. 1, 3 and 4)
16 Conduit (FIGS. 1 and 8)
18 Overhead Tank (FIGS. 1 and 3)
19 Return Line (FIGS. 1, 3 and 8)
20 Flow Sensor System (SPS) (FIGS. 1, 2, 4 and 8)
21 Flow Indicator & Transmitter (FIT) (FIGS. 1 and 3)
22 Surge Pressure Valve (SPV) (FIGS. 1, 2 and 8)
23 Velocity Indicator & Transmitter (VIT) (FIGS. 2 and 8)
24 Recirculation Valve (RCV) (FIGS. 1, 3 and 8)
25 Pressure Indicator & Transmitter (PIT) (FIG. 2)
26, 28 Surge Relief Valves (SRV) (FIG. 1)
26 Surge Relief Valve (FIGS. 2 and 8)
27 Shock Absorber Drum (FIGS. 2 and 4)
29 Outlet Line (FIGS. 1, 2, 3, 4 and 8)
30, 32 Hydro-Turbines (FIG. 1)
40 Hydraulic System (FIG. 2)
42 Surge Conduit (FIGS. 2 and 4)
46 Turbine (FIGS. 2 and 4)
48 Pump (FIG. 3)
49 Reservoir (FIG. 3)
50 Hydraulic Circuit (FIG. 3)
52 Surge Conduits (FIGS. 3 and 9)
53 Feed Line (FIGS. 1, 2, 3, 4 and 8)
54 Instrumentation Logic Panel (FIGS. 3 and 9)
57 Velocity Indicator & Transmitter (VIT) (FIGS. 3 and 4)
58 Surge Pressure Valve (SPV) (FIGS. 3 and 4)
59 Reservoir (FIG. 4)
60 Surge Relief Valve (SRV) (FIGS. 3 and 4)
62 Pressure Indicator & Transmitter (PIT) (FIGS. 3 and 4)
64 Hydro-Turbine (FIGS. 3 and 8)

1. A system for producing electrical energy utilizing the principle of hydraulic water hammer, which comprises:
a) a hydraulic system which includes a hydraulic feed line;
b) a surge conduit connected to said feed line and capable of carrying a liquid at a first predetermined velocity and pressure;
c) a plurality of sensors and valves coupled to said surge conduit, said valves being capable of selectively opening and closing periodically and continuously in response to respective signals provided by a selective number of said sensors;
d) an instrumentation system operatively connected to said system of valves and sensors to selectively and sequentially control the opening and closing of selected valves in a manner to periodically and continuously induce pressure surge waves of relatively elevated pressures in said liquid; and
e) means for directing said pressure surge waves to compatible devices for producing electric power generation.

2. The hydraulic system according to claim 1 wherein said compatible devices for producing electrical energy from said pressure surge waves of elevated pressures comprise hydro-turbines.

3. The system according to claim 2, wherein said compatible devices further comprise electric generating equipment coupled to said hydro-turbines.

4. The system according to claim 1, wherein the liquid is water, and said plurality of sensors and valves comprise at least one each of a Surge Pressure Valve, a Flow Indicator and Transmitter, a Pressure Indicator and Transmitter, a Velocity Indicator and Transmitter and Surge Relief Valve respectively, arranged to continuously and periodically induce pressure surge waves in said hydraulic surge system.

5. The system according to claim 4, wherein said surge conduit is comprised of carbon steel having a polymer internal coating.

6. The system according to claim 5, wherein the cross-sectional size of said surge conduit is less than the cross-sectional size of said feed line.

7. The system according to claim 1, wherein said feed line is connected to a system of dual surge conduit sub-systems, each said surge conduit forming part of a separate and individual surge system associated with a respective plurality of sensors and valves arranged to sense water pressure, velocity and flow, and to selectively signal a respective surge pressure valve to close to thereby produce a pressure surge wave.

8. The system according to claim 7, wherein said sensors and transmitters are adapted to periodically and continuously produce said pressure surge waves.

9. The system according to claim 8, further comprising hydro-turbines, and means to selectively direct said pressure surge waves to said hydro-turbines to power said hydro-turbines.

10. The system according to claim 9, wherein said hydro-turbines are each coupled to an electric generating device which produces green electrical power when powered by said hydro-turbine.

11. The system according to claim 7, wherein each said surge conduit sub-system is adapted to continuously and periodically produce surge pressure waves in alternate cycles of between one and two seconds, in cascade mode, wherein one conduit system is in suction mode when the other conduit system is in discharge mode, and vice versa.

12. The system according to claim 11, where each said surge conduit is comprised of carbon-steel having a low friction internal coating to reduce traction.

13. The system according to claim 12, wherein said low friction internal coating is a synthetic polymer.

14. The system according to claim 13, wherein each said surge conduit sub-system is periodically injected with a drag reducing agent which reduces friction between the flow of water and the internal wall of said conduits.

15. The system according to claim 12, wherein each said surge conduit is comprised of a straight pipe.

16. The system according to claim 12, wherein each said surge conduit is comprised of a spirally wound pipe.

17. The system according to claim 16, wherein said drag reducing agent is a long chain polymer.

18. The system according to claim 2, wherein said compatible devices comprise pumps and compressors.

19. A system for increasing hydraulic pressure in a hydraulic system utilizing the principle of hydraulic water hammer, which comprises:
a) a hydraulic system which includes a hydraulic feed line capable of carrying a liquid at a first predetermined velocity and pressure;
b) a surge conduit connected to said hydraulic feed line, said surge conduit having a cross-sectional size less than the cross-sectional size of said feed line;
c) a plurality of sensors and valves coupled to said hydraulic system, said sensors and valves being capable of selectively opening and closing periodically and continuously in response to signals provided by a selected number of said sensors;
d) an instrumentation flow sensor system operatively connected to said system of valves and sensors to selectively control the opening and closing of said valves in a manner to periodically and continuously induce pressure surge waves of relatively elevated pressures in said liquid; and
e) means for directing said pressure surge waves to a high liquid pressure outlet.

20. The system according to claim 16, where the liquid is water.

21. The system according to claim 20, wherein said pressure surge waves are directed to drive pumps, compressors or a hydraulic transient energy generating system.

22. A system adapted for increasing hydraulic pressure in a hydraulic system, utilizing the principle of hydraulic water hammer, and for utilizing said increased water pressure for useful purposes, which comprises:
a) a feed line adapted for receiving water from a source;
b) a pump for pumping the water in said feed line;
c) a surge conduit connected to said feed line and capable of carrying water at a first predetermined velocity and pressure;
d) an outlet line communicating with said surge conduit;
e) a plurality of velocity sensors, surge pressure valves, and surge relief valves coupled to said surge conduit, said surge pressure valves being adapted to close when receiving a signal from one of said respective sensors indicating that the water velocity has reached a pre-determined value, said valve closure producing a pressure surge wave in said system which delivers high pressure water into said outlet line, whereby a surge relief valve returns to a closed position once the pressure in said conduit declines to a normal preset value and at the same time, a pressure sensor reopens said respective surge pressure valve to permit water to flow through and attain a predetermined velocity once again; and
f) an instrumentation system controlled by a software program operatively connected to said system of valves and sensors to selectively control the opening and closing of said valves in a manner to continuously and periodically induce pressure surge waves of relatively elevated pressures in said liquid.

23. The system according to claim 22, wherein at least two of said surge conduit systems are connected to said feed line to operate in cascade mode, wherein one of said conduit systems is operative in suction mode when the other conduit system is in discharge mode and vice versa.
